(19) United States
(12) Patent Application Publication
(10) Pub. No.: US 2013/0149877 A1
(43) Pub. Date: Jun. 13, 2013

(54) FPC CONNECTOR

(71) Applicant: ACES ELECTRONICS CO., LTD., Jhongli City (TW)

(72) Inventor: Yuan-Huang LIU, Taoyuan City (TW)

(73) Assignee: ACES ELECTRONICS CO., LTD., Jhongli City (TW)

(21) Appl. No.: 13/709,726

(22) Filed: Dec. 10, 2012

(30) Foreign Application Priority Data
Dec. 13, 2011 (TW) 100223509

(51) Int. Cl. H01R 12/77

(52) U.S. Cl. CPC H01R 12/771
USPC 439/61

(57) ABSTRACT

A FPC connector includes an electrically insulative connector body defining vertically spaced rows of curved slots and upright straight slots, conducting terminals respectively mounted in the lower row of upright straight slots, press members respectively mounted in the upper row of curved slots for holding down a flexible printed circuit board on front contact portions of the conducting terminals, a swivel cover coupled to the electrically insulative connector body and the press members and biasable relative to the electrically insulative connector body and the press member between a horizontal close position and a vertical open position, and two stop members bilaterally mounted in the electrically insulative connector body to stop the swivel cover in place.

This application claims the priority benefit of Taiwan patent application number 100223509, filed on Dec. 13, 2011.

### BACKGROUND OF THE INVENTION

1. Field of the Invention

The present invention relates to electrical connector technology and more particularly, to a FPC (Flexible Printed Circuit) connector for high frequency application, which effectively reduces high frequency interference.

2. Description of the Related Art

Following fast development of computer, network and electronic information technologies, various advanced electronic devices and systems are well developed and widely used for different applications. Further, it is the market trend to create electronic devices having light, thin, short and small characteristics. In consequence, circuit board electronic components must be made extremely strong, small and precise. Further, many different electrical connectors may be used in an electronic apparatus to connect different components and parts to a circuit board for signal transmission. Designing an electrical connector for signal transmission must consider the factors of signal transmission capacity and body size miniaturization. Electrical connectors for FPC (Flexible Printed Circuit) application are then created. Electrical connectors for FPC application have the characteristics of large amount of conducting terminals and low profile. These electrical connectors are intensively used in computers and related peripheral equipments for high frequency signal transmission. However, because these electrical connectors have a high pin count, interferences (statistical interference, electromagnetic interference, impedance matching, noise interference, cross-talk interference) may occur during transmission of a high frequency signal if the pins (conducting terminals) are curved.

Taiwan Patent Number: M304148 discloses an electrical connector entitled “Electrical Connector for Flexible Printed Circuit Board”. According to this design, as shown in FIGS. 7-9, a press member C is inserted into a front opening A1 of a housing A to let top arms B1 and bottom contact portions B2 of respective conducting terminals B be engaged into respective notches C3 of the press member C and positioned in the bottom side of the front opening A1 of the housing A respectively. At this time, rear bonding portions B3 of the conducting terminals B suspend outside the housing A for bonding to an external mainboard, and respective positioning points C4 in the notches C3 of the press member C are respectively positioned in respective bottom grooves B11 of the top arms B1 of respective conducting terminals B. Thereafter, support members D are respectively inserted into respective mounting portions A2 of the housing A to support respective support arms C2 of the press member C, holding down the positioning points C4 of the press member C in the bottom grooves B11 of the respective conducting terminals B. At this time, press portions C5 of the press member C are kept between the top arms B1 and bottom contact portions B2 of the conducting terminals B. Thus, the press member C can be turned relative to the housing A between an open position and a close position and will not fall out of the housing A.

When connecting the electrical connector to a flexible printed circuit board E, attach the support arms C2 of the press member C to the respective support members D, and then move an operating portion C1 of the press member C to bias smoothly arched surfaces C21 of the support arms C2 relative to the respective support members D from horizontal to vertical while keeping the positioning points C4 of the press member C in the bottom grooves B11 of the respective conducting terminals B, and then insert the flexible printed circuit board E into the gap between the top arms B1 and bottom contact portions B2 of the conducting terminals B, and then turn the press member C backwardly from vertical to horizontal to force the press portions C5 of the press member C against the flexible printed circuit board E, enabling the flexible printed circuit board E to be clamped between the press portions C5 of the press member C and respective protrusions B21 of the bottom contact portions B2 of the conducting terminals B. Thus, the flexible printed circuit board E and the conducting terminals B are electrically conducted. Subject to the design of the smoothly arched surfaces C21 of the support arms C2, the press member C can be smoothly biased relative to the respective support members D between the horizontal close position and the vertical open position. Further, by means of using the support members D to support the support arms C2 of the press member C, the positioning points C4 of the press member C are positively kept in the bottom grooves B11 of the respective conducting terminals B.

However, according to the aforesaid prior art design, the conducting terminals B have a roughly C-shaped profile where the top arms B1 respectively extend from the respective bottom contact portions B2 of the conducting terminals B without contacting the flexible printed circuit board E. During application, high frequency signal is transmitted through the flexible printed circuit board E and the bottom contact portions B2 and bonding portions B3 of the conducting terminals B to the mainboard. The branched top arms B1 tend to cause a skin effect, limiting the cross-sectional conducting terminal area available to carry alternating electron flow, increasing the resistance of the conducting terminals above what the conducting terminals would normally be for direct current. In consequence, signal transmission bandwidth and quality may not reach the designed standards, affecting normal functioning of the electronic device (computer or network equipment).

Therefore, it is desirable to provide an electrical connector for high frequency application that eliminates the aforesaid problems.

### SUMMARY OF THE INVENTION

The present invention has been accomplished under the circumstances in view. It is therefore the main object of the present invention to provide a FPC (Flexible Printed Circuit) connector, which is practical for use with a flexible printed circuit board for high frequency application, facilitates installation, and effectively reduces noises during application.

To achieve this and other objects of the present invention, a FPC (Flexible Printed Circuit) connector comprises an electrically insulative connector body defining vertically spaced rows of curved slots and upright straight slots, conducting terminals respectively mounted in the lower row of upright straight slots, press members respectively mounted in the upper row of curved slots for holding down a flexible printed circuit board on front contact portions of the conducting terminals, a swivel cover coupled to the electrically insulative connector body and the press members and biasable relative to the electrically insulative connector body and the press member between a horizontal close position and a vertical open position, and two stop members bilaterally mounted in the electrically insulative connector body to stop the swivel cover in place. The separated design of the conducting terminals and the press members eliminates the problem of skin effect, avoiding noise generation and statistic interference.

Further, the press members each comprise a mounting portion and a positioning portion joined together to exhibit a substantially U-shaped (or 7-shaped) profile and mounted together in one curved slot in an upright holder base of the electrically insulative connector body positively. Thus, biasing the swivel cover between the horizontal close position and the vertical open position does not cause a concentration of stress to damage the inside wall of the upright holder bass of the electrically insulative connector body around the curved slots and the vertical straight slots.

### BRIEF DESCRIPTION OF THE DRAWINGS

FIG. 1 is an oblique top elevational view of a FPC connector in accordance with the present invention.

FIG. 2 is an exploded view of the FPC connector in accordance with the present invention.

FIG. 3 corresponds to FIG. 2 when viewed from another angle.

FIG. 4 is a sectional front view of the FPC connector in accordance with the present invention.

FIG. 5 is a schematic elevational applied view of the present invention, illustrating the swivel cover lifted to the vertical open position before insertion of a flexible printed circuit board.

FIG. 6 is a sectional side view, in an enlarged scale, of FIG. 5.

FIG. 7 corresponds to FIG. 5, illustrating the flexible printed circuit board inserted into the accommodation open chamber of the electrically insulative connector body and the swivel cover closed.

FIG. 8 is an exploded view of an electrical connector according to the prior art.

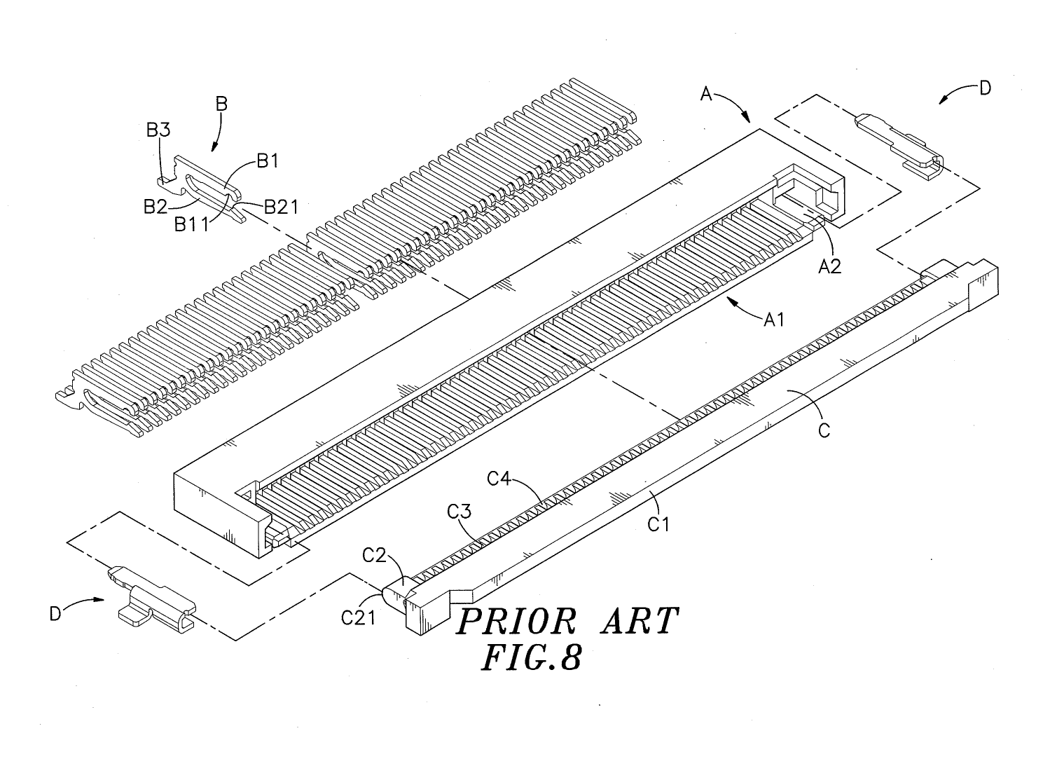

FIG. 9 is a sectional side view, in an enlarged scale of the prior art electrical connector, illustrating the press member opened and a flexible printed circuit board partially inserted into the front opening of the housing.

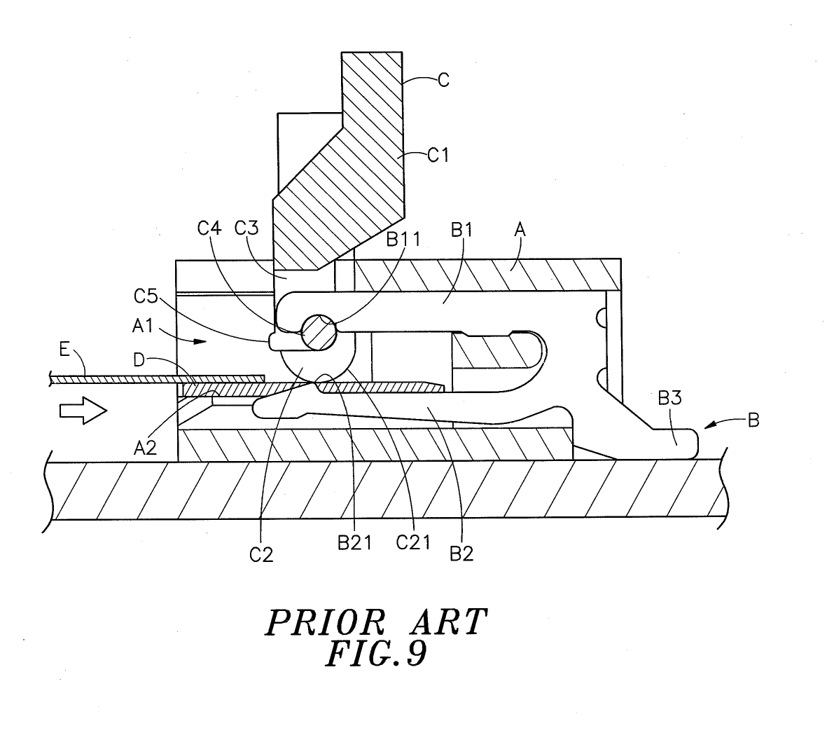

FIG. 10 corresponds to FIG. 9, illustrating the printed circuit board installed and the press member closed.

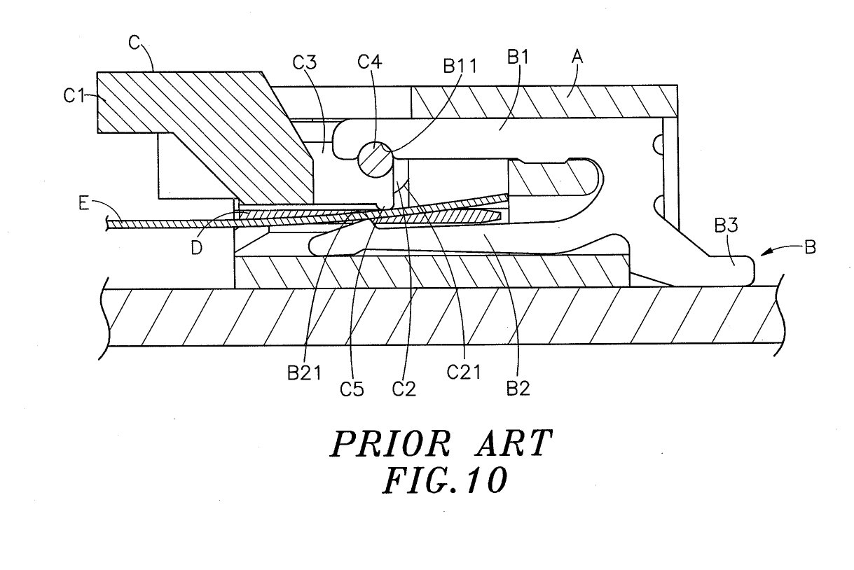

### DETAILED DESCRIPTION OF THE PREFERRED EMBODIMENT

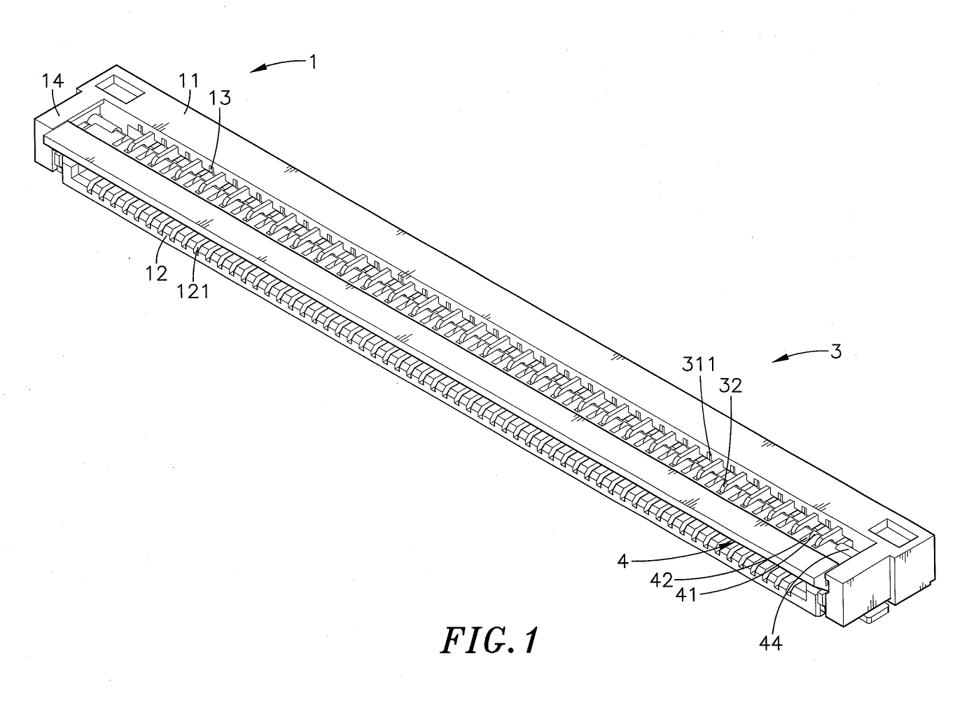

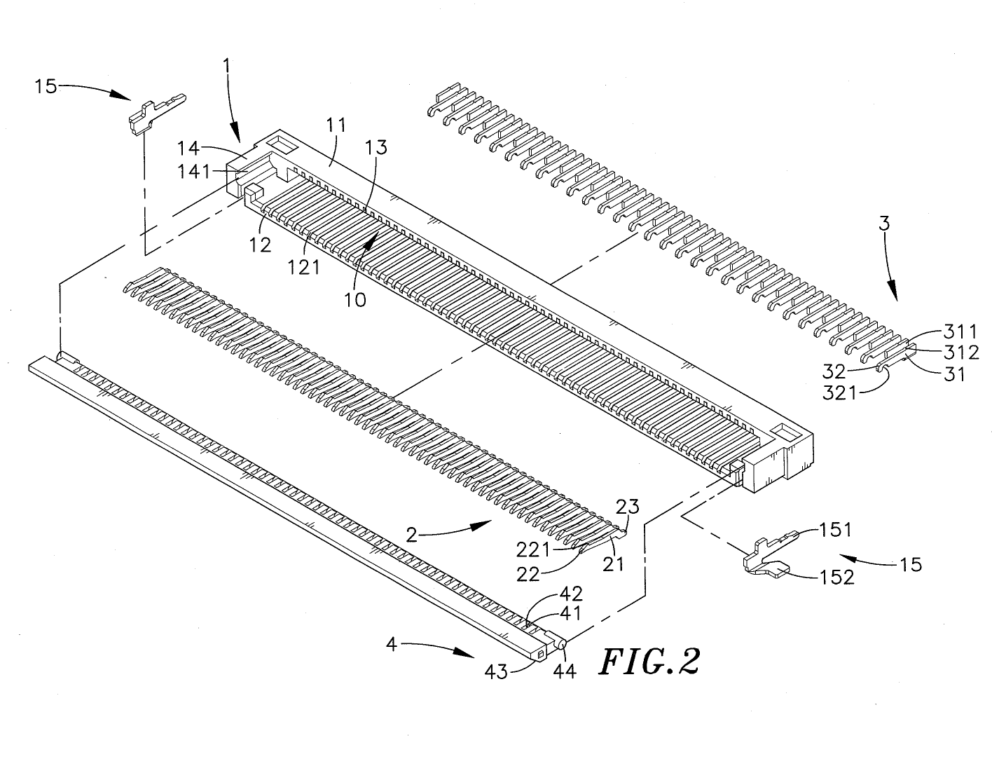

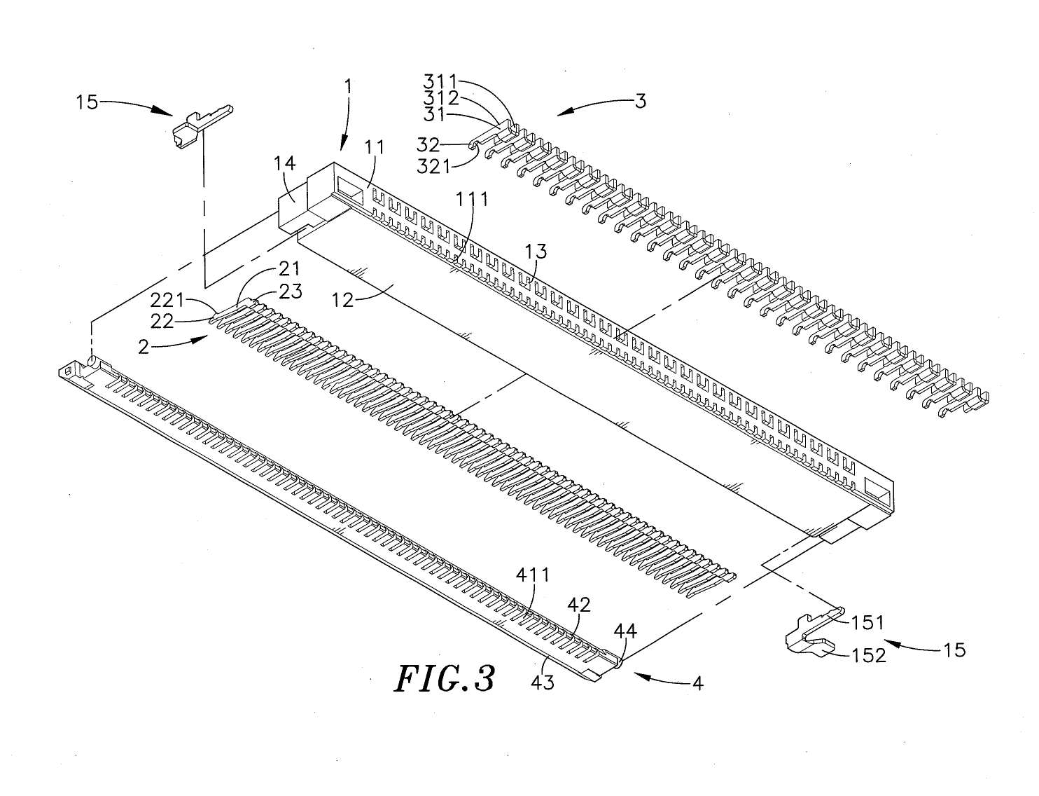

Referring to FIGS. 1, 2, 3 and 4, a FPC (Flexible Printed Circuit) connector in accordance with the present invention is shown. The FPC connector comprises an electrically insulative connector body 1, a set of conducting terminals 2, a set of press members 3, and a swivel cover 4.

The electrically insulative connector body 1 comprises an upright holder base 11, a horizontal bottom panel 12 forwardly extended from the upright holder base 11, an accommodation open chamber 10 surrounded by the upright holder base 11 and the horizontal bottom panel 12 for accommodating a flexible printed circuit board 5, a row of curved slots 13 and a row of vertical straight slots 111 cut through opposing front and back sides of the upright holder base 11 and arranged at different elevations, a plurality of terminal grooves 121 located at the top wall of the horizontal bottom panel 12 and respectively forwardly extended from the respective bottom ends of the vertical straight slots 111, two horizontal shafts 14 respectively forwardly extended from the upright holder base 11 at two opposite lateral sides relative to the horizontal bottom panel 12, a sliding groove 141 located at an inner side of each of the two horizontal shafts 14 and facing toward the accommodation open chamber 10, and two electrically insulative stop members 15 respectively mounted in the upright holder base 11 of the electrically insulative connector body 1 between the horizontal bottom panel 12 and the two horizontal shafts 14. Each electrically insulative stop member 15 comprises an anchoring portion 151 affixed to the upright holder base 11, and a stop plate portion 152 inserted into the front end of the sliding groove 141 of one respective horizontal shaft 14.

The conducting terminals 2 each comprise a mounting portion 21 mounted in one respective vertical straight slot 111 of the upright holder base 11 of the electrically insulative connector body 1, a front contact portion 22 forwardly extended from the mounting portion 21 and positioned in one respective terminal groove 121 of the horizontal bottom panel 12 of the electrically insulative connector body 1, and a rear bonding portion 23 backwardly extended from the mounting portion 21 and suspending outside of the upright holder base 11 of the electrically insulative connector body 1.

The press members 3 each comprise a mounting portion 31 and a positioning portion 311 joined together to exhibit a substantially U-shaped profile and mounted together in one curved slot 13 in the upright holder base 11 of the electrically insulative connector body 1 positively, a plurality of friction portions 312 respectively located at the mounting portion 31 and the positioning portion 311 at a top side and forced into friction engagement with the peripheral wall of the respective curved slot 13 in the upright holder base 11 of the electrically insulative connector body 1, a front pressure arm 32 forwardly extended from the mounting portion 31, and a smoothly arched locating notch 321 located at a front bottom side of the front pressure arm 32. Further, the press members 3 can be selectively made out of a metal or plastic material.

The swivel cover 4 comprises a front base panel 411, a plurality of elongated slots 42 cut through opposing top and bottom sides of the front base panel 411 in a parallel manner, a plurality of axles 41 respectively and transversely disposed in a front side of each of the elongated slots 42 and axially aligned in line, and an operating portion 43 located at a back side of the front base panel 41, and two pivot rods 44 respectively extended from two opposite lateral sides of the front base panel 41.

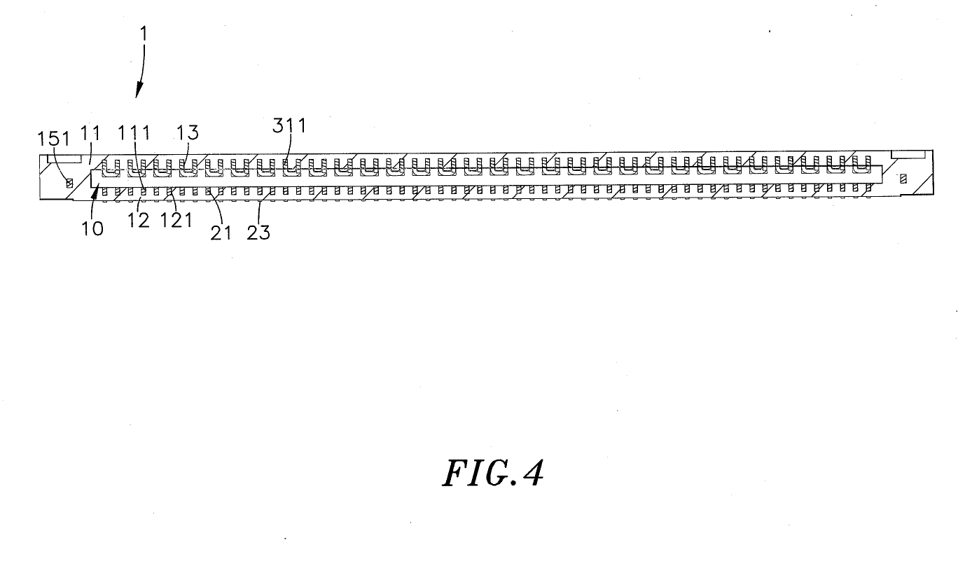

Referring to FIGS. 5-7 and FIG. 4 again, when assembling the FPC connector, insert the swivel cover 4 into the accommodation open chamber 10 of the electrically insulative connector body 1 to couple the two pivot rods 44 of the swivel cover 4 to the respective sliding grooves 141 at the two horizontal shafts 14 of the electrically insulative connector body 1 and to have the smoothly arched locating notches 321 of the press members 3 be respectively coupled to the axles 41 of the swivel cover 4 in the respective elongated slots 42, and then bilaterally fasten the anchoring portions 151 of the electrically insulative stop members 15 to the upright holder base 11 of the electrically insulative connector body 1 to let the stop plate portions 152 of the electrically insulative stop members 15 be inserted into the respective front ends of the sliding grooves 141 of the respective horizontal shafts 14. Thus, the swivel cover 4 is coupled to the electrically insulative connector body 1 and the press members 3, and can be turned up and down relative to the electrically insulative connector body 1 within a predetermined angle, for example, 90° angle.

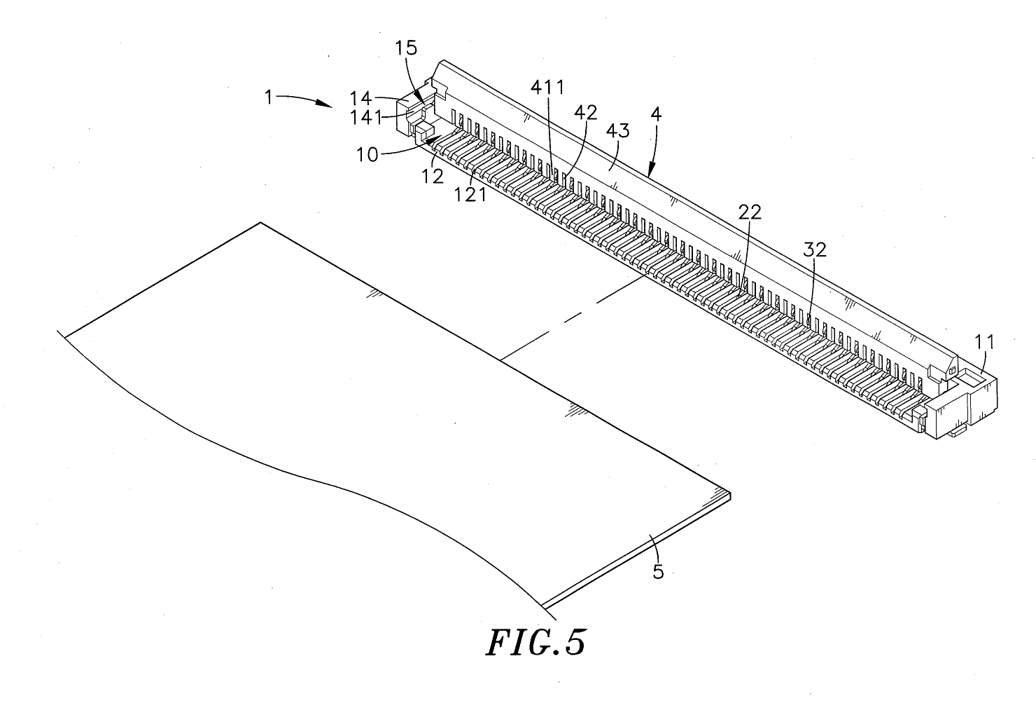

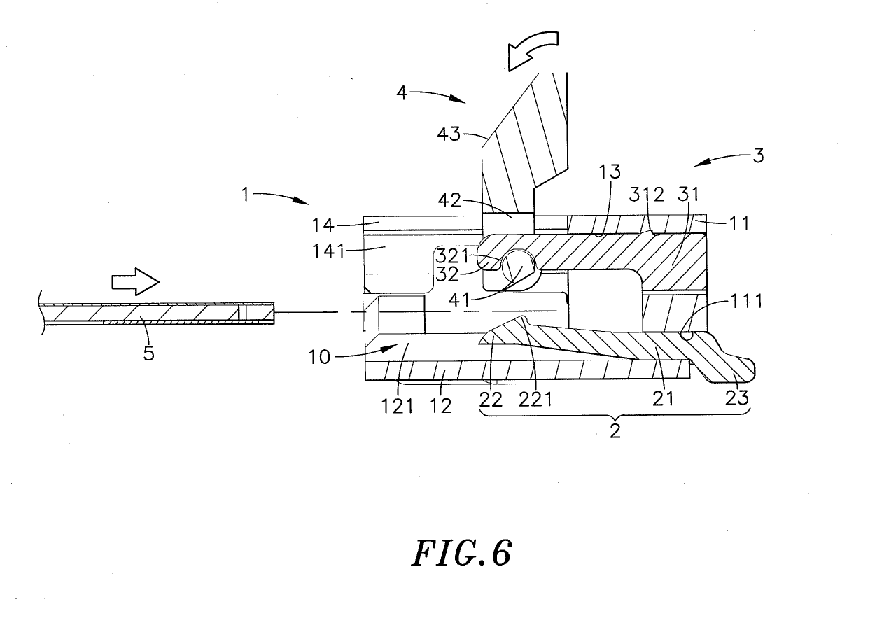

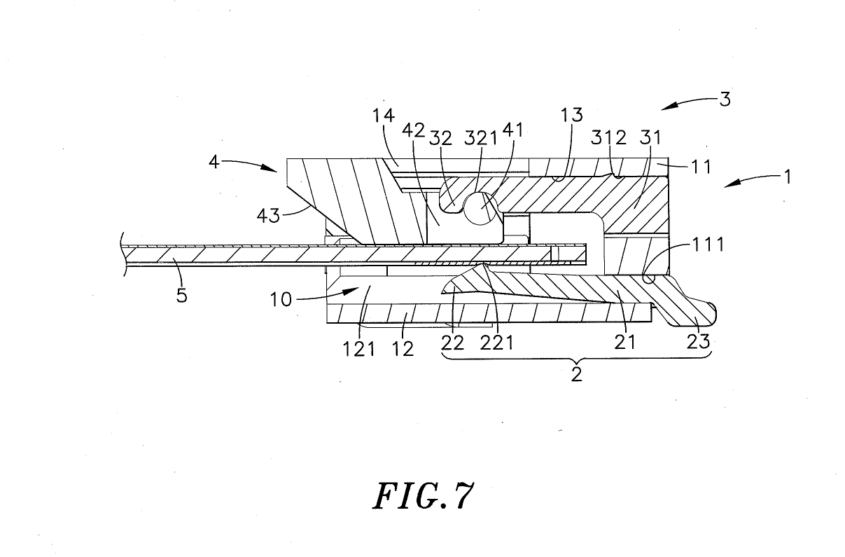

Referring to FIGS. 1 and 5-7 again, when installing a flexible printed circuit board 5 in the FPC connector, move the operating portion 43 to turn the swivel cover 4 relative to the electrically insulative connector body 1 from a horizontal close position shown in FIGS. 1 and 7 to a vertical open position shown in FIGS. 5 and 6, and then insert the flexible printed circuit board 5 into the accommodation open chamber 10 of the electrically insulative connector body 1 above the front contact portion 22 of the conducting terminals 2, and then turn the swivel cover 4 from the vertical open position back to the horizontal close position to press the bottom wall of the front base panel 411 of the swivel cover 4 on the flexible printed circuit board 5, enabling the flexible printed circuit board 5 to be sandwiched between the front base panel 411 of the swivel cover 4 and the protrusions 221 at the front contact portions 22 of the conducting terminals 2. Thus, the conducting terminals 2 and the flexible printed circuit board 5 are electrically conducted.

According to the present invention, the separated design of the conducting terminals 2 and the press members 3 eliminates the problem of skin effect as seen in the prior art design, avoiding noise generation and statistic interference. Further, the configuration design of the mounting portions 31 and positioning portions 311 of the press members 3 can be positively positioned in the curved slots 13 of the upright holder base 11 of the electrically insulative connector body 1 to bear the pressure from the swivel cover 4. Therefore, biasing the swivel cover 4 between the horizontal close position and the vertical open position does not cause a concentration of stress to damage the inside wall of the upright holder base 11 of the electrically insulative connector body 1 around the curved slots 13 and the vertical straight slots 111. Further, in the present preferred embodiment, the mounting portion 31 and positioning portion 311 of each press member 3 are joined together to exhibit a substantially U-shaped profile. Alternatively, the mounting portion 31 and positioning portion 311 of each press member 3 can be joined together to exhibit a substantially L-shaped or 7-shaped profile.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A FPC connector for electrically connecting a FPC to a PCB of an electric device, the FPC connector comprising:
an electrically insulative connector body comprising an upright holder base, a horizontal bottom panel forwardly extended from said upright holder base, an accommodation open chamber surrounded by said upright holder base and said horizontal bottom panel for accommodating a flexible printed circuit board, and a row of curved slots and a row of vertical straight slots cut through opposing front and back sides of said upright holder base and arranged at different elevations;
a plurality of conducting terminals each comprising a mounting portion respectively mounted in said vertical straight slots of said upright holder base of said electrically insulative connector body, a front contact portion forwardly extended from said mounting portion and positioned on said horizontal bottom panel of said electrically insulative connector body and a rear bonding portion backwardly extended from said mounting portion and suspending outside of said upright holder base of said electrically insulative connector body for bonding to an external circuit board;
a plurality of press members each comprising a mounting portion and a positioning portion joined together and mounted together in said curved slots in said upright holder base of said electrically insulative connector body, a front pressure arm forwardly extended from the mounting portion of the respective said press member and a smoothly arched locating notch located at a front bottom side of said front pressure arm; and
a swivel cover coupled to said electrically insulative connector body and said press members and biasable relative to said electrically insulative connector body and said press member between a horizontal close position and a vertical open position, said swivel cover comprising a front base panel, a plurality of elongated slots cut through opposing top and bottom sides of said front base panel in a parallel manner and respectively coupled to said front pressure arms of said press members and a plurality of axles respectively and transversely disposed in a front side of each of said elongated slots and respectively coupled to the smoothly arched locating notches of said press members.

2. The FPC connector as claimed in claim 1, wherein the mounting portion and positioning portion of each said press member are joined together to exhibit a substantially U-shaped profile.

3. The FPC connector as claimed in claim 1, wherein the mounting portion and positioning portion of each said press member are joined together to exhibit a substantially 7-shaped profile.

4. The FPC connector as claimed in claim 1, wherein said electrically insulative connector body further comprises two horizontal shafts respectively forwardly extended from said upright holder base at two opposite lateral sides relative to said horizontal bottom panel, and a sliding groove located at an inner side of each of said two horizontal shafts and facing toward said accommodation open chamber, and two electrically insulative stop members respectively mounted in said upright holder base between said horizontal bottom panel and said two horizontal shafts, each said electrically insulative stop member comprising an anchoring portion affixed to said upright holder base and a stop plate portion inserted into a front end of one said sliding groove in one said horizontal shaft; said swivel cover further comprises two pivot rods respectively extended from two opposite lateral sides of said front base panel thereof and respectively coupled to said sliding grooves at said horizontal shafts of said electrically insulative connector body and stopped in said sliding grooves by the stop plate portions of said stop members.

5. The FPC connector as claimed in claim 1, wherein each said conducting terminal further comprises a protrusion located at a top side of the front contact portions thereof.

6. The FPC connector as claimed in claim 1, wherein each said press member further comprises a plurality of friction portions respectively located at the mounting portion and positioning portion thereof at a top side and forced into friction engagement with a peripheral wall of the respective said curved slot in said upright holder base of said electrically insulative connector body.

7. The FPC connector as claimed in claim 1, wherein said electrically insulative connector body further comprises a plurality of terminal grooves located at a top wall of said horizontal bottom panel and respectively forwardly extended from respective bottom ends of said vertical straight slots of said electrically insulative connector body.
